(19) United States
(12) Patent Application Publication
(10) Pub. No.: US 2014/0147101 A1
(43) Pub. Date: May 29, 2014

(54) IMAGE ROTATION METHOD AND SYSTEM FOR VIDEO PLAYER

(71) Applicant: TENCENT TECHNOLOGY (SHENZHEN) COMPANY LIMITED, Shenzhen City (CN)

(72) Inventors: HONG-XING SU, Shenzhen City (CN); SI-KE ZHONG, Shenzhen City (CN); SEN LIN, Shenzhen City (CN); JING LAI, Shenzhen City (CN)

(73) Assignee: TENCENT TECHNOLOGY (SHENZHEN) COMPANY LIMITED, Shenzhen City (CN)

(21) Appl. No.: 14/167,999

(22) Filed: Jan. 30, 2014

Related U.S. Application Data
(63) Continuation-in-part of application No. PCT/CN2013/070473, filed on Jan. 15, 2013.

(30) Foreign Application Priority Data
Jan. 18, 2012 (CN) 201210015447.7

(51) Int. Cl. H04N 9/79

(52) U.S. Cl. CPC H04N 9/7921
USPC 386/300

(57) ABSTRACT

An image rotation method and an image rotation system for a video player are provided. The image rotation method includes the following steps. Firstly, an image rotation request from a terminal is received. Then, a source video file is decoded and a rotation processing operation is performed on the decoded source video file in response to the image rotation request, so that a rotated image of the source video file is displayed. At last, the rotated image is displayed on a display device of the terminal. By the image rotation method and the image rotation system, the image in the video player can be rotated by a specified angle. Consequently, the problems of the conventional video player will be overcome. Moreover, since the problems of causing the compressed and distorted image are eliminated, the quality of the played and displayed image is enhanced.

### CROSS-REFERENCE TO RELATED APPLICATION

This application is a continuation-in-part (CIP) application of International (PCT) Patent Application No. PCT/CN2013/070473 filed on Jan. 15, 2013, now pending and designating the United States, which also claims benefit of China Patent Application No. 201210015447.7, filed on Jan. 18, 2012. The entirety of the above-mentioned patent applications is hereby incorporated by reference herein and made a part of this specification.

### FIELD OF THE INVENTION

The present disclosure relates to a video playback technology, and particularly to an image rotation method and an image rotation system for a video player.

### BACKGROUND OF THE INVENTION

Conventionally, during a process of playing a video file in an online video player, the contents to be watched have to be rotated by a specified angle because of the video contents, the playing device or the usage scenarios. For example, the video file may be captured by a mobile phole in a landscape shooting mode or a portrait shooting mode. The captured contents of the video file are usually watched in a default display mode. However, the captured contents of the video file in the default display mode are sometimes unable to be normally watched. For example, some of the video contents are not displayed at the basic 12:9 or 16:9 aspect ratio, but they are displayed at the 9:12 or 9:16 aspect ratio. Under this circumstance, the displayed video contents are compressed and distorted. Moreover, the conventional online video player can only support the default portrait display mode. In other words, the conventional online video player fails to rotate the video contents by a specified angle and fails to display the rotated video contents.

### SUMMARY OF THE INVENTION

The present disclosure provides an image rotation method and an image rotation system for rotating an image in a video player in order to enhance the image quality.

An aspect of the present disclosure provides an image rotation method for a video player. The image rotation method includes steps of receiving an image rotation request from a terminal, decoding a source video file to acquire YUV data of the decoded source video file, converting the YUV data into RGB data and rotating the RGB data, converting the rotated RGB data into a YUV data format of an rotated image of the source video file to be displayed, and displaying the rotated image on a display device of the terminal.

Preferably, the RGB data are rotated in response to a multi-media extension instruction.

Preferably, the image rotation method further includes a step of locking an aspect ratio of the rotated image when the rotated image is displayed.

Preferably, an image of the source video file is rotated by 90 degrees in response to the image rotation request.

Another aspect of the present disclosure provides an image rotation system for a video player. The image rotation system includes a request receiving unit and a rotation processing unit. The request receiving unit is configured to receive an image rotation request from a terminal. The rotation processing unit is configured to decode a source video file and perform a rotation processing operation on the decoded source video file in response to the image rotation request, so that a rotated image of the source video file is displayed. The rotation processing unit includes a decoding module for decoding the source video file to acquire YUV data of the decoded source video file, a first conversion module for converting the YUV data into RGB data and rotating the RGB data in response to a multi-media extension instruction, and a second conversion module for converting the rotated RGB data into a YUV data format to be displayed.

Preferably, when the rotated image is displayed, an aspect ratio of the rotated image is fixed.

Preferably, an image of the source video file is rotated by 90 degrees in response to the image rotation request.

Preferably, the image rotation system further includes a triggering unit. The triggering unit includes a clockwise rotation icon and an anticlockwise rotation icon. When the clockwise rotation icon or the anticlockwise rotation icon is triggered, the image rotation request is issued.

Another aspect of the present disclosure provides an image rotation method for a video player. The image rotation method includes steps of receiving an image rotation request from a terminal, decoding a source video file and performing a rotation processing operation on the decoded source video file in response to the image rotation request so that a rotated image of the source video file is displayed, and displaying the rotated image on a display device of the terminal.

Preferably, the step of decoding the source video file and performing the rotation processing operation on the decoded source video file includes sub-steps of: decoding the source video file to acquire YUV data of the decoded source video file, converting the YUV data into RGB data and rotating the RGB data in response to a multi-media extension instruction, and converting the rotated RGB data into a YUV data format to be displayed.

Preferably, the image rotation method further includes a step of locking an aspect ratio of the rotated image when the rotated image is displayed.

Preferably, an image of the source video file is rotated by 90 degrees in response to the image rotation request.

Another aspect of the present disclosure provides an image rotation system for a video player. The image rotation system includes a request receiving unit and a rotation processing unit. The request receiving unit is configured to receive an image rotation request from a terminal. The rotation processing unit is configured to decode a source video file and perform a rotation processing operation on the decoded source video file in response to the image rotation request, so that a rotated image of the source video file is displayed.

Preferably, the rotation processing unit includes a decoding module for decoding the source video file to acquire YUV data of the decoded source video file, a first conversion module for converting the YUV data into RGB data and rotating the RGB data in response to a multi-media extension instruction, and a second conversion module for converting the rotated RGB data into a YUV data format to be displayed.

Preferably, when the rotated image is displayed, an aspect ratio of the rotated image is fixed.

Preferably, an image of the source video file is rotated by 90 degrees in response to the image rotation request.

### BRIEF DESCRIPTION OF THE DRAWINGS

The advantages of the present disclosure will become more readily apparent to those ordinarily skilled in the art after reviewing the following detailed description and accompanying drawings, in which:

FIG. 1 is a flowchart illustrating an image rotation method for a video player according to an embodiment of the present invention;

FIG. 2 is a flowchart illustrating the procedures of performing a rotation processing operation of the image rotation method of FIG. 1;

FIG. 3 schematically illustrates a floating toolbar for initiating the image rotation method according to an embodiment of the present invention;

FIG. 4 is a schematic functional block diagram illustrating an image rotation system for a video player according to an embodiment of the present invention;

FIG. 5 is a schematic functional block diagram illustrating the rotation processing unit of the image rotation system of FIG. 4; and

FIG. 6 illustrates a terminal with which some embodiments of the invention are implemented.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

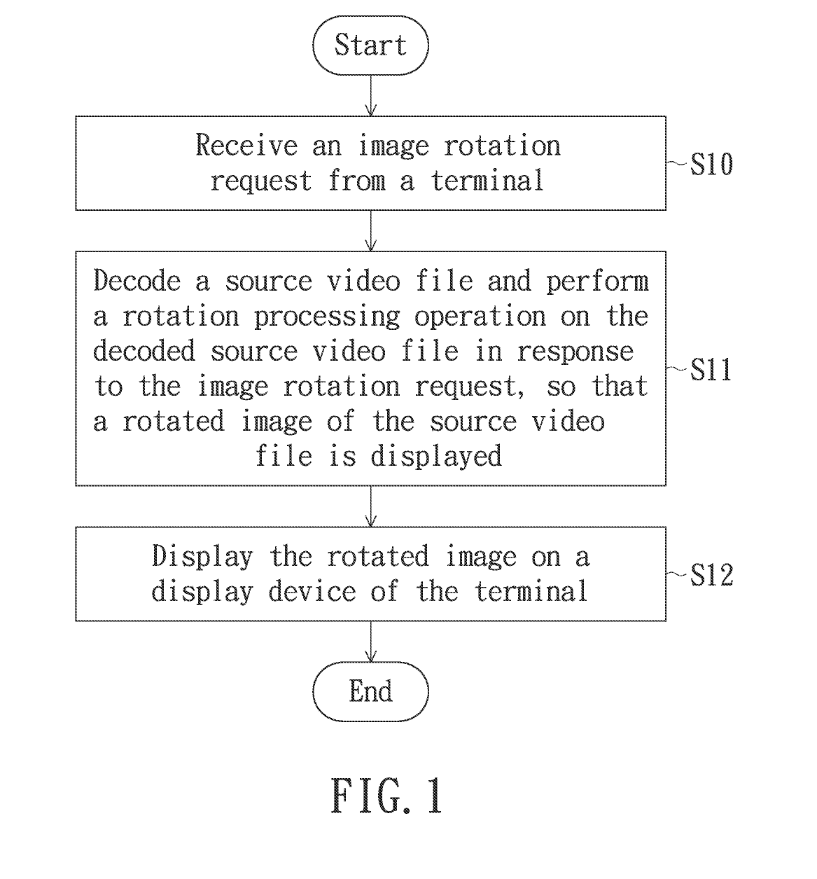

FIG. 1 is a flowchart illustrating an image rotation method for a video player according to an embodiment of the present invention. Firstly, an image rotation request from a terminal is received (Step S10). Then, a source video file is decoded and a rotation processing operation is performed on the decoded source video file in response to the image rotation request, so that a rotated image of the source file is displayed (Step S11). At last, the rotated image is displayed on a display device of the terminal (Step S12).

As previously described, the conventional online video player can only support the default portrait display mode. That is, the conventional online video player fails to rotate the video contents by a specified angle and fails to display the rotated video contents. In accordance with the image rotation method of the present disclosure, after an image rotation request from a terminal is received, the image is rotated by a specified angle in response to the image rotation request. Consequently, the problems of the conventional video player are solved, and the quality of played and displayed image will be enhanced.

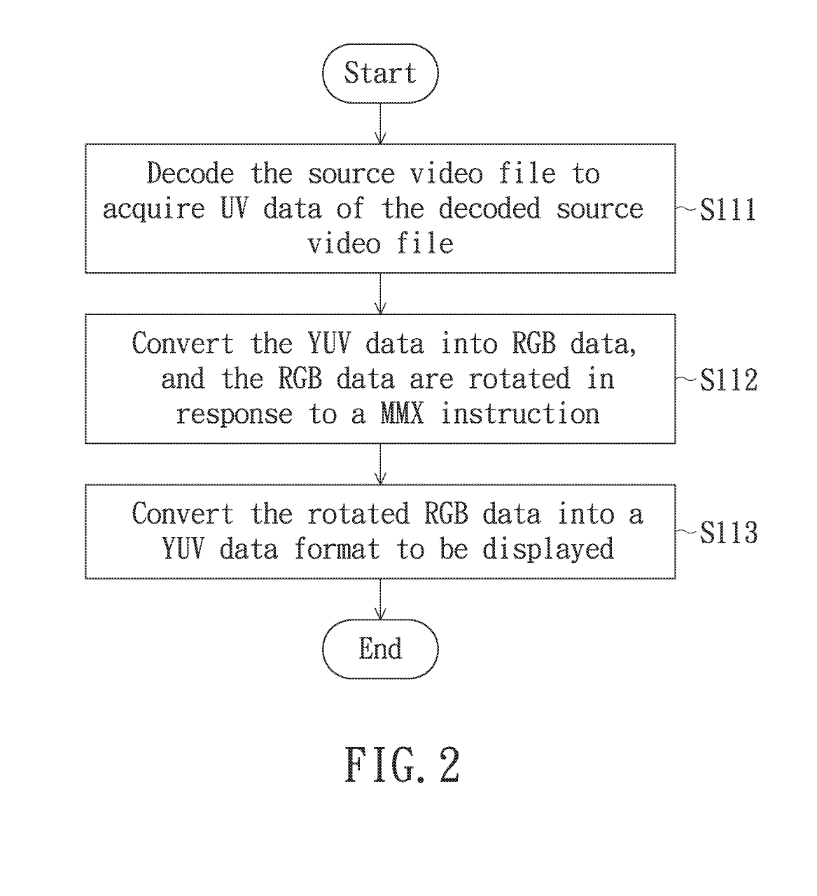

The detailed procedures of the step S11 will be illustrated with reference to a flowchart of FIG. 2. Firstly, after the source video file is decoded, YUV data of the decoded source video file are acquired (Step S111). Then, the YUV data of the decoded source video file are converted into RGB data, and the RGB data are rotated in response to a multi-media extension (MMX) instruction (Step S112). Then, the rotated RGB data are converted into a YUV data format to be displayed (Step S113).

After the source video file is received by the video player, the source video file is decoded, so that YUV data of the decoded source video file are acquired. Then, the YUV data of the decoded source video file are converted into RGB data. In response to a multi-media extension (MMX) instruction, the RGB data are rotated. Then, the rotated RGB data are converted into a YUV format to be displayed. In this context, the YUV data include but are not limited to YV12 data, NV12 data, YUY2 data, UYVY data, and so on. The RGB data include but are not limited to RGB32 data. The step of converting the YUV data into the specified-format RGB data in response to the MMX instruction includes the following sub-steps: storing an initial address of the YUV data into ESI, ECX and EDX registers in response to a MOV instruction, and storing the YUV data into MM0˜MM7 registers in response to a MOVD/MOVQ instruction. Since the MM0˜MM7 registers can process data of 64 to 128 bits, the processing speed is increased. Moreover, since the MMX instruction is an assembly language for operating the data of 64 to 128 bits, the data processing efficiency is largely enhanced.

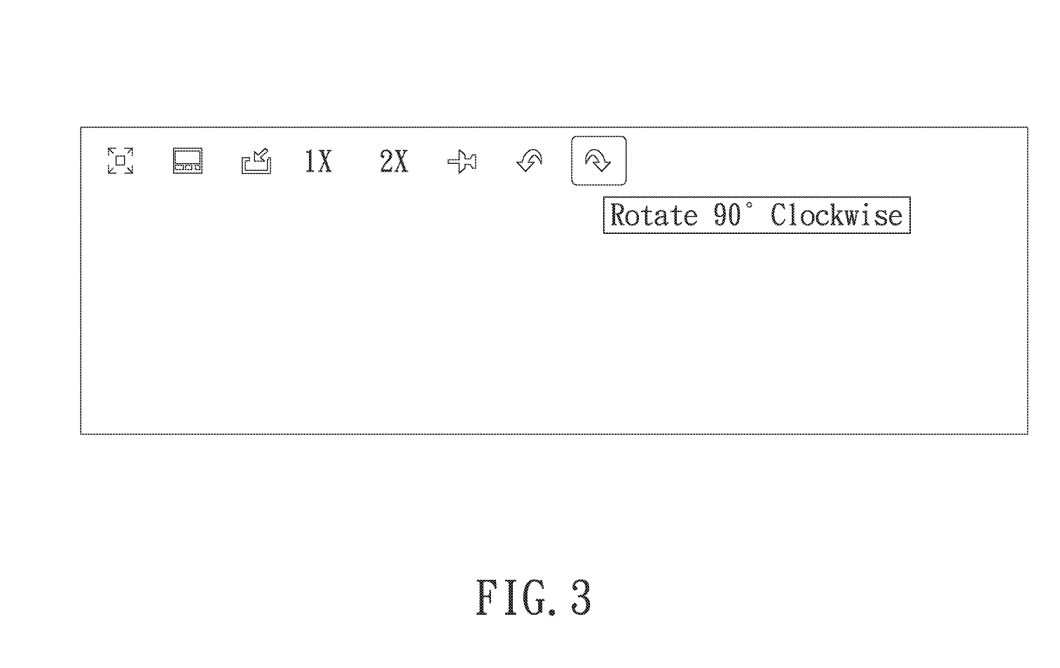

An implementation example of performing the image rotation method of the present invention will be illustrated as follows. Firstly, a floating toolbar (see FIG. 3) is shown on a top of the video player at the terminal. In this context, the floating toolbar is also referred as a triggering unit. The floating toolbar additionally comprises at least two rotation icons. The two rotation icons include a clockwise rotation icon and an anticlockwise rotation icon. By clicking each of the two rotation icons once, the image of the source video file is rotated by a specified angle (e.g. 90 degrees) in a direction corresponding to the rotation icon. These rotation icons are allowed to be clicked for an unlimited number of times. Moreover, if the time interval between two successive click actions is shorter than a time threshold (e.g. 0.3 second), the latter click action may be ignored. In a case that a mouse cursor is placed over one of the two rotation icons, a tiny popup window (e.g. TIPS) appears to prompt the end user a short description of the clicked icon (e.g. “Rotate 90° Clockwise” or “Rotate 90° Anticlockwise”). If the mouse cursor is no longer placed over the rotation icon or the time period of continuously placing the mouse cursor over the rotation icon is longer than a time threshold (e.g. 3 seconds), the tiny popup window (e.g. TIPS) is closed. In response to a click action, the image is rotated once. Moreover, in a case that the target file is switched or the software is restarted, the image is watched in a default display mode. Furthermore, during showing of the rotated image, an aspect ratio (i.e. a ratio of a horizontal width of the image to a vertical height of the image) may be fixed. If the width or the height of a display region of the video player is insufficient to display the image in default size, the image is scaled down while remaining the fixed aspect ratio and the scale-down image is centered.

Furthermore, the functions of the two rotation icons may be also implemented by pressing corresponding shortcut keys on a keyboard or keypad of the terminal. For example, the function of the clockwise rotation icon may be implemented by pressing a shortcut key “W”, and the function of the anticlockwise rotation icon may be implemented by pressing a shortcut key “E”.

From the above descriptions, the present disclosure provides an image rotation method for rotating an image in a video player. After a streaming media file is decoded and a data format conversion is performed, the purpose of rotating the image of the streaming media file is achieved. By the image rotation method of the present disclosure, the problems of causing the compressed and distorted image in the default display mode of the video player will be overcome. Consequently, the quality of the played and displayed image will be enhanced.

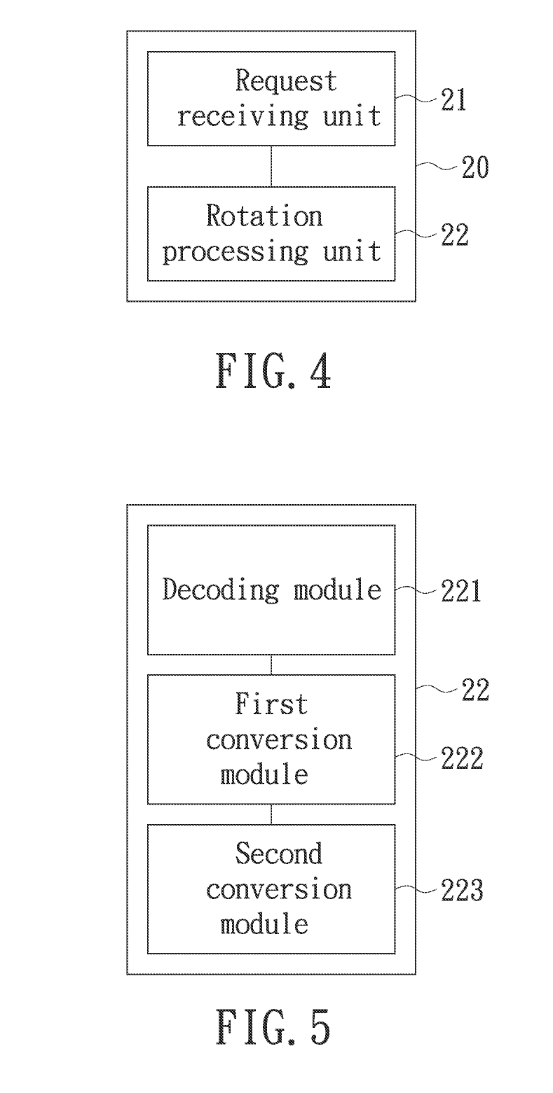

FIG. 4 is a schematic functional block diagram illustrating an image rotation system for a video player according to an embodiment of the present invention. The image rotation system 20 comprises a request receiving unit 21 and a rotation processing unit 22. The request receiving unit 21 is configured to receive an image rotation request from a terminal. In response to the image rotation request, the rotation processing unit 22 may decode a source video file and perform a rotation processing operation on the decoded source video file, so that a rotated image of the source video file is displayed.

As previously described, the conventional online video player can only support the default portrait display mode. That is, the conventional online video player fails to rotate the video contents by a specified angle and fails to display the rotated video contents. In accordance with the image rotation system of the present disclosure, after an image rotation request from a terminal is received, the image is rotated by a specified angle in response to the image rotation request. Consequently, the problems of the conventional video player are solved, and the quality of played and displayed image will be enhanced.

FIG. 5 is a schematic functional block diagram illustrating the rotation processing unit of the image rotation system of FIG. 4. As shown in FIG. 5, the rotation processing unit 22 comprises a decoding module 221, a first conversion module 222, and a second conversion module 223. The decoding module 221 is configured to decode a source video file, thereby acquiring YUV data of the decoded source video file. By the first conversion module 222, the YUV data of the decoded source video file are converted into RGB data, and the RGB data are rotated in response to a multi-media extension (MMX) instruction. By the second conversion module 223, the rotated RGB data are converted into a YUV format to be displayed.

After the source video file is received by the decoding module 221, the source video file is decoded, so that YUV data of the decoded source video file are acquired. Then, by the first conversion module 222, the YUV data of the decoded source video file are converted into RGB data, and the RGB data are rotated in response to a multi-media extension (MMX) instruction. Then, by the second conversion module 223, the rotated RGB data are converted into a YUV format to be displayed. The step of converting the YUV data into the specified-format RGB data in response to the MMX instruction includes the following sub-steps: storing an initial address of the YUV data into ESI, ECX and EDX registers in response to a MOV instruction, and storing the YUV data into MM0˜MM7 registers in response to a MOVD/MOVQ instruction. Since the MM0˜MM7 registers can process data of 64 to 128 bits, the processing speed is increased. Moreover, since the MMX instruction is an assembly language for operating the data of 64 to 128 bits, the data processing efficiency is largely enhanced.

An implementation example of the image rotation system of the present invention will be illustrated as follows. Firstly, a floating toolbar is shown on a top of the video player at the terminal. The floating toolbar additionally comprises at least two rotation icons. The two rotation icons include a clockwise rotation icon and an anticlockwise rotation icon. By clicking each of the two rotation icons once, the image of the source video file is rotated by a specified angle (e.g. 90 degrees) in a direction corresponding to the rotation icon. These rotation icons are allowed to be clicked for an unlimited number of times. Moreover, if the time interval between two successive click actions is shorter than a time threshold (e.g. 0.3 second), the latter click action may be ignored. In a case that a mouse cursor is placed over one of the two rotation icons, a tiny popup window (e.g. TIPS) appears to prompt the end user a short description of the clicked icon (e.g. “Rotate 90° Clockwise” or “Rotate 90° Anticlockwise”). If the mouse cursor is no longer placed over the rotation icon or the time period of continuously placing the mouse cursor over the rotation icon is longer than a time threshold (e.g. 3 seconds), the tiny popup window (e.g. TIPS) is closed. In response to a click action, the image is rotated once. In a case that the target file is switched or the software is restarted, the image is watched in a default display mode. Furthermore, during showing of the rotated image, an aspect ratio (i.e. a ratio of a horizontal width of the image to a vertical height of the image) may be fixed. If the width or the height of a display region of the video player is insufficient to display the image in default size, the image is scaled down while remaining the fixed aspect ratio and the scale-down image is centered.

Furthermore, the functions of the two rotation icons may be also implemented by pressing corresponding shortcut keys on a keyboard or keypad of the terminal. For example, the function of the clockwise rotation icon may be implemented by pressing a shortcut key “W”, and the function of the anticlockwise rotation icon may be implemented by pressing a shortcut key “E”.

From the above descriptions, the present disclosure provides an image rotation system for rotating an image in a video player. After a streaming media file is decoded and a data format conversion is performed, the purpose of rotating the image of the streaming media file is achieved. By the image rotation system of the present disclosure, the problems of causing the compressed and distorted image in the default display mode of the video player will be overcome. Consequently, the quality of the played and displayed image will be enhanced.

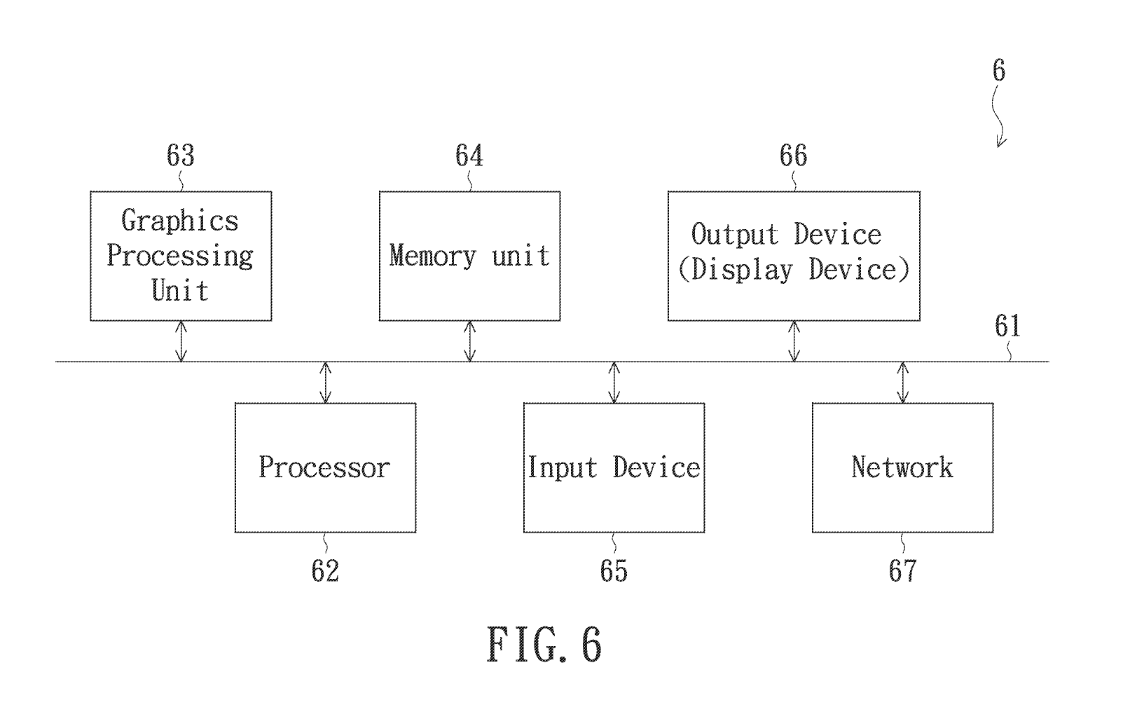

FIG. 6 illustrates a terminal 6 with which some embodiments of the invention are implemented. The terminal 6 may be a computer, a phone, a personal digital assistant (PDA) or any other electronic device. The terminal 6 may include, but not limited to, a bus 61, at least one processor 62, a graphics processing unit (GPU) 63, at least one memory unit 64, an input device 65 and an output device 66.

The bus 61 collectively represents all peripheral or chipset buses that communicatively connect internal devices of the terminal 6. For example, the bus 61 is in communication with the processor 62, the graphics processing unit 63 and the memory unit 64.

The processor 62 retrieves instructions and data from the memory unit 64 to execute and process the image rotation methods provided in the embodiments of the invention. The processor 62 may be a single processor or a multi-core processor in different embodiments. Some instructions about image processing are executed by the graphics processing unit 63.

The memory unit 64 may be a volatile memory or a non-volatile memory including at least one of a read-only-memory (ROM), a system memory and a permanent storage device, configured to store data and executable instructions of the image rotation methods provided in the embodiments of the present invention. Some embodiments of the invention use a mass-storage device (such as a magnetic disk or an optical disk and its corresponding disk drive) or a removable storage device (e.g. USB flash drive) as the permanent storage device.

The bus 61 also connects to the input device 65 and the output device 66. The input device 65 enables the user to communicate information and select commands to the terminal 6. The input device 65 may include a keyboard and a pointing device. The output device 66 displays images, e.g. the rotated image of the source video file and the video player, generated by the terminal 6. For example, the output device 66 includes a display device, such as cathode ray tubes (CRT) or liquid crystal displays (LCD). Some embodiments include a touch panel that function as both input device and output device.

The bus 61 also couples the terminal 6 to a network 67 through a network adapter (not shown). In this manner, the terminal 6 can communicate with other terminals through a local area network (LAN), a wide area network (WAN), an Intranet, or the Internet with a wired or wireless mode.

As used in this specification and any claims of this application, the terms “computer”, “terminal”, “processor”, “memory” and “display device” all refer to electronic devices. These terms exclude people or groups of people.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image rotation method for a video player, the image rotation method comprising steps of:
receiving an image rotation request from a terminal;
decoding a source video file, thereby acquiring YUV data of the decoded source video file;
converting the YUV data into RGB data and rotating the RGB data;
converting the rotated RGB data into a YUV data format of an rotated image of the source video file to be displayed; and
displaying the rotated image on a display device of the terminal.

2. The image rotation method according to claim 1, wherein the RGB data are rotated in response to a multi-media extension instruction.

3. The image rotation method according to claim 1, further comprising a step of locking an aspect ratio of the rotated image when the rotated image is displayed.

4. The image rotation method according to claim 1, wherein an image of the source video file is rotated by 90 degrees in response to the image rotation request.

5. An image rotation system for a video player, the image rotation system comprising:
a request receiving unit configured to receive an image rotation request from a terminal; and
a rotation processing unit configured to decode a source video file and perform a rotation processing operation on the decoded source video file in response to the image rotation request, so that a rotated image of the source video file is displayed, wherein the rotation processing unit comprises:
a decoding module configured to decode the source video file, thereby acquiring YUV data of the decoded source video file;
a first conversion module configured to convert the YUV data into RGB data and rotate the RGB data in response to a multi-media extension instruction; and
a second conversion module configured to convert the rotated RGB data into a YUV data format to be displayed.

6. The image rotation system according to claim 5, wherein when the rotated image is displayed, an aspect ratio of the rotated image is fixed.

7. The image rotation system according to claim 5, wherein an image of the source video file is rotated by 90 degrees in response to the image rotation request.

8. The image rotation system according to claim 5, further comprising a triggering unit, wherein the triggering unit comprises a clockwise rotation icon and an anticlockwise rotation icon, wherein when the clockwise rotation icon or the anticlockwise rotation icon is triggered, the image rotation request is issued.

9. An image rotation method for a video player, the image rotation method comprising steps of:
receiving an image rotation request from a terminal;
decoding a source video file and performing a rotation processing operation on the decoded source video file in response to the image rotation request, so that a rotated image of the source video file is displayed; and
displaying the rotated image on a display device of the terminal.

10. The image rotation method according to claim 9, wherein the step of decoding the source video file and performing the rotation processing operation on the decoded source video file comprises sub-steps of:
decoding the source video file, thereby acquiring YUV data of the decoded source video file;
converting the YUV data into RGB data and rotating the RGB data in response to a multi-media extension instruction; and
converting the rotated RGB data into a YUV data format to be displayed.

11. The image rotation method according to claim 10, further comprising a step of locking an aspect ratio of the rotated image when the rotated image is displayed.

12. The image rotation method according to claim 10, wherein an image of the source video file is rotated by 90 degrees in response to the image rotation request.

13. The image rotation method according to claim 9, further comprising a step of locking an aspect ratio of the rotated image when the rotated image is displayed.

14. The image rotation method according to claim 9, wherein an image of the source video file is rotated by 90 degrees in response to the image rotation request.

15. An image rotation system for a video player, the image rotation system comprising:
a request receiving unit configured to receive an image rotation request from a terminal; and
a rotation processing unit configured to decode a source video file and perform a rotation processing operation on the decoded source video file in response to the image rotation request, so that a rotated image of the source video file is displayed.

16. The image rotation system according to claim 15, wherein the rotation processing unit comprises:
a decoding module configured to decode the source video file, thereby acquiring YUV data of the decoded source video file;
a first conversion module configured to convert the YUV data into RGB data and rotate the RGB data in response to a multi-media extension instruction; and
a second conversion module configured to convert the rotated RGB data into a YUV data format to be displayed.

17. The image rotation system according to claim 16, wherein when the rotated image is displayed, an aspect ratio of the rotated image is fixed.

18. The image rotation system according to claim 16, wherein an image of the source video file is rotated by 90 degrees in response to the image rotation request.

19. The image rotation system according to claim 15, wherein when the rotated image is displayed, an aspect ratio of the rotated image is fixed.

20. The image rotation system according to claim 15, wherein an image of the source video file is rotated by 90 degrees in response to the image rotation request.
